(19) United States
(12) Patent Application Publication
(10) Pub. No.: US 2023/0192131 A1
(43) Pub. Date: Jun. 22, 2023

(54) AUTOMATED DRIVING COLLISION PREDICTION

(71) Applicants: Joseph Burtch, Lake Orion, MI (US); Sina Davani, Troy, MI (US); Raymundo Magana, Rochester, MI (US)

(72) Inventors: Joseph Burtch, Lake Orion, MI (US); Sina Davani, Troy, MI (US); Raymundo Magana, Rochester, MI (US)

(21) Appl. No.: 17/645,662

(22) Filed: Dec. 22, 2021

(51) Int. Cl. B60W 60/00; G06V 20/58

(52) U.S. Cl. CPC B60W 60/0011; B60W 60/0015; G06V 20/58; B60W 2554/80

(57) ABSTRACT

A method of defining an autonomous vehicle path according to a disclosed exemplary embodiment includes, among other possible things, defining a boundary that utilizes sensor data indicative of features constraining a possible vehicle path, generating a reference path with a vehicle autonomous control system based on the defined boundary, defining a clearance distance for the vehicle relative to the reference path, detecting a conflict at a point along the reference path that is responsive to a distance between the reference path and the defined boundary being less than the defined clearance, and communicating the potential conflict to the vehicle autonomous control system.

### TECHNICAL FIELD

The present disclosure relates to a method and device for predicting a collision for automated driving and driver assist systems.

### BACKGROUND

Automated driving and driver assist systems gather information about an environment surrounding a vehicle and use that information to plan and move along a desired path. Movement along the desired path requires detection of any objects present in the environment surrounding the vehicle and along the path. Sensors gather information about the environment surrounding the vehicle and may accumulate large amounts of information and data that can be challenging to process. Automotive manufactures are continuously seeking more efficient information processing methods to improve operation of vehicle systems.

The background description provided herein is for the purpose of generally presenting a context of this disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A method of defining an autonomous vehicle path according to a disclosed exemplary embodiment includes, among other possible things, defining a boundary that utilizes sensor data indicative of features constraining a possible vehicle path, generating a reference path with a vehicle autonomous control system based on the defined boundary, defining a clearance distance for the vehicle relative to the reference path, detecting a conflict at a point along the reference path that is responsive to a distance between the reference path and the defined boundary being less than the defined clearance, and communicating the potential conflict to the vehicle autonomous control system.

In another exemplary embodiment of the foregoing method, the reference path comprises a plurality of points and the defined clearance comprises a circle centered on at least some of the plurality of points.

In another exemplary embodiment of any of the foregoing methods, the circle comprises a diameter that is equal to or greater than a greatest width of the vehicle.

In another exemplary embodiment of any of the foregoing methods, the sensor data comprises a plurality of points that are indicative of a boundary object and defining the boundary comprises defining a line based on the plurality of points.

In another exemplary embodiment of any of the foregoing methods, the boundary object comprises a boundary separating different driving surfaces.

In another exemplary embodiment of any of the foregoing methods, the boundary object comprises an object extending upwardly from a driving surface.

Another exemplary embodiment of any of the foregoing methods further comprises detecting an object with the defined boundary based on sensor data and defining an object clearance around the detected object.

In another exemplary embodiment of any of the foregoing methods, the object clearance is defined about the object and includes a spacing that provides a clearance between a vehicle moving along the reference path.

In another exemplary embodiment of any of the foregoing methods, the object clearance comprises a collision radius that is at least half as wide as the vehicle.

An autonomous vehicle control system according to another exemplary embodiment includes, among other possible things, a controller mountable within a vehicle that is configured to define a boundary utilizing sensor data indicative of features constraining a possible vehicle path, generate a reference path with a vehicle autonomous control system based on the defined boundary, define a clearance distance for the vehicle relative to the reference path, detect a conflict at a point along the reference path responsive to a distance between the reference path and the defined boundary being less than the defined clearance, and communicate the potential conflict to the vehicle autonomous control system.

In another embodiment of the foregoing autonomous vehicle control system, the reference path comprises a plurality of points and the defined clearance comprises a circle centered on at least some of the plurality of points.

In another embodiment of any of the foregoing autonomous vehicle control systems, the circle comprises a diameter equal to or greater than a greatest width of the vehicle.

Another embodiment of any of the foregoing autonomous vehicle control systems further includes at least one sensor configured to generate data comprising a plurality of points indicative of a boundary object proximate the vehicle and the controller is further configured define the boundary based on the plurality of points.

In another embodiment of any of the foregoing autonomous vehicle control systems, the controller is further configured to detect an object within the boundary based on data from the sensor and to generate an object clearance around the detected object.

In another embodiment of any of the foregoing autonomous vehicle control systems, the object clearance comprises a circle centered on the detected object. The circle includes a radius at least as wide as half a greatest width of the vehicle.

In another embodiment of any of the foregoing autonomous vehicle control systems, the controller is configured to define the object clearance as a spacing that provides a clearance between a vehicle moving along the reference path.

Another embodiment of any of the foregoing autonomous vehicle control systems further includes at least one sensor generating information indicative of vehicle motion, position and direction and the controller is further configured to utilize information indictive of vehicle motion, position and direction to determine the reference path.

In another embodiment of any of the foregoing autonomous vehicle control systems, the at least one sensor comprises at least one of a radar system, camera system or a lidar.

A non-transitory computer readable storage medium including instructions for operating an autonomous vehicle control system, the computer readable storage medium according to another disclosed exemplary embodiment includes, among other possible things, instructions prompting a controller located within the autonomous vehicle to define a boundary utilizing sensor data indicative of features constraining a possible vehicle path, instructions prompting the controller to generate a reference path with a vehicle autonomous control system based on the defined boundary, instructions prompting the controller to define a clearance distance for the vehicle relative to the reference path, instructions prompting the controller to detect a conflict at a point along the reference path responsive to a distance between the reference path and the defined boundary being less than the defined clearance, and instructions prompting the controller to communicate the potential conflict to the vehicle autonomous control system.

Another embodiment of the foregoing non-transitory computer readable storage medium further includes instructions for prompting the controller to detect an object with the defined boundary based on sensor data and define an object clearance around the detected object.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example vehicle including an autonomous vehicle control system.

FIG. 2 is a schematic view of a plurality of sensor data points utilized to define a boundary according to a disclosed embodiment.

FIG. 3 is a schematic view of a path defined by vehicle control system relative to a defined boundary.

FIG. 4 is a schematic view of an object detected by the vehicle control system relative to the defined path.

FIG. 5 is a flow diagram illustrating a disclosed method for defining a boundary path and detecting potential collisions.

### DETAILED DESCRIPTION

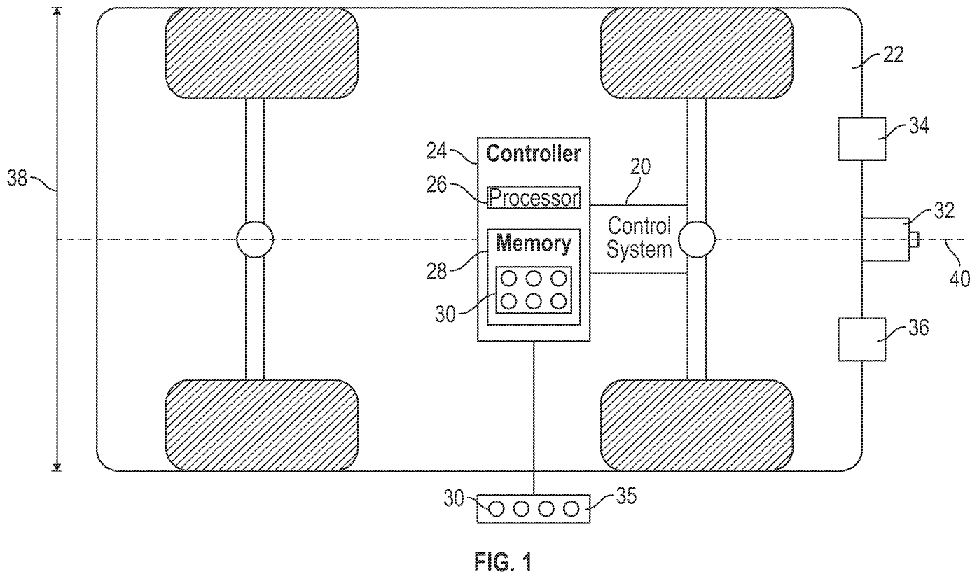

Referring to FIG. 1, a vehicle 22 is schematically shown and includes an autonomous driver assist control system 20. The autonomous driver assist control system 20 obtains information from various sensors located on the vehicle 22 to block a desired vehicle path relative to objects in boundary structures. In one disclosed embodiment, the sensors may include a camera 32, a radar system 36, or a lidar system schematically shown at 34. It should be appreciated that although each of the sensor systems 32, 34, 36 are illustrated schematically by way of example that other sensor systems that are utilized to detect objects surrounding a vehicle 22 would also be within the scope and contemplation of this disclosure.

The vehicle 22 is shown schematically and includes a width 38 and is disposed along a centerline 40. The vehicle 22 may be fully autonomous or may operate semi-autonomously. The example vehicle 22 may be a car, truck or large truck for pulling a trailer. Moreover, the vehicle 22 may be of any configuration that operates in some way autonomously.

The example controller 24 may be a separate controller dedicated to the control system 20 are may be part of an overall vehicle controller. Accordingly, the example controller 24 relates to a device and system for performing necessary computing or calculation operations of the control system 20. The controller 24 may be specially constructed for operation of the control system 20, or it may comprise at least a general-purpose computer selectively activated or reconfigured by software instructions 30 stored in the memory device 28. The computing system can also consist of a network of (different) processors.

The example vehicle controller 24 includes a processor 26 and the memory device 28. The memory device 28 provides for the storage of the software instructions 30 that prompt operation of the controller 24. The software instructions 30 may be embodied in a computer program that uses data obtained from the sensor systems 32, 34 and 36 and data stored in the memory device that may be required for its execution.

The instructions 30 for configuring and operating the controller 24 and control system 20 and the processor 26 are embodied in software instructions that may be stored on a computer readable medium, schematically shown at 35. The computer readable, medium may be embodied in structures such as, but is not limited to, any type of disk including floppy disks, optical disks, CD-ROMs, magnetic-optical disks, read-only memories (ROMs), random access memories (RAMS), EPROMs, EEPROMs, magnetic or optical cards, application specific integrated circuits (ASICs), or any type of media suitable for storing electronic instructions, and each coupled to a computer system bus. The disclosed computer readable medium may be a non-transitory medium such as those examples provided.

Moreover, the software instructions 30 may be saved in the memory device 28. The disclosed memory device 28, may can include any one or combination of volatile memory elements (e.g., random access memory (RAM, such as DRAM, SRAM, SDRAM, VRAM, etc.) and/or nonvolatile memory elements (e.g., ROM, hard drive, tape, CD-ROM, etc.). The software instructions 30 in the memory device 28 may include one or more separate programs, each of which includes an ordered listing of executable instructions for implementing logical functions. The disclosed controller 24 is configured to execute the software instructions 30 stored within the memory device 28, to communicate data to and from the memory device 28, and to generally control operations pursuant to the software. Software in memory, in whole or in part, is read by the processor 26, perhaps buffered within the processor, and then executed.

The vehicle control system 20 utilizes information obtained from the sensor systems 32, 34, 36 to define a map that includes boundaries and other objects that must be avoided by the vehicle 22. The control system 20 may further operate according to a predefined map stored in the memory device 28.

One a path for the vehicle 22 is determined, the control system 20 operates the vehicle to move along the path. However, the control system 20 is also required to monitor and detect any objects along the path that may cause undesired contact. Accordingly, the disclosed example vehicle control system 20 is to detect possible collisions along the defined reference path.

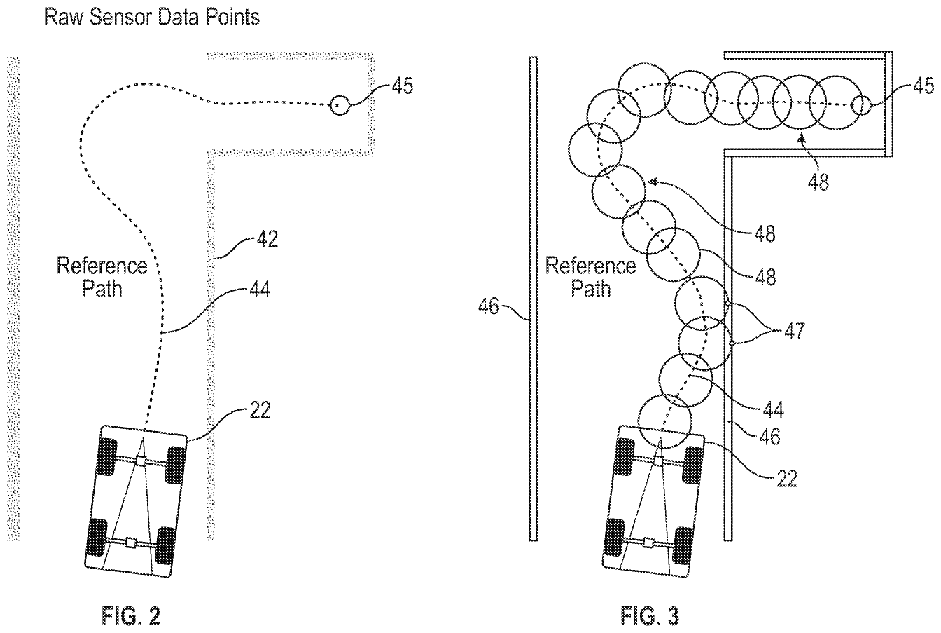

Referring to FIG. 2 with continued reference to FIG. 1, the example vehicle control system 20 accumulates a plurality of raw data points schematically shown at 42 relative to a desired reference path 44. The plurality of data points 42 are schematic representations of actual data points that are detected by at least one or all of the sensor systems 32, 34, 36. The raw sensor data 42 may be indicative of a vertical structure such as a wall, vegetation or other structures on which the vehicle 22 is not meant to drive through. The raw sensor data 42 may also be indicative of an edge of a driveway between a hard drivable surface and another surface on which it is not desired for the vehicle to proceed. The discontinuity represented by the data points 42 is utilized to define a boundary that sets limits for vehicle operation.

Referring to FIG. 3 with continued reference to FIGS. 1 and 2, the vehicle control system 20 utilizes the plurality of sensor points indicated at 42 in FIG. 2 to define a boundary 46 as shown in FIG. 3. The boundary 46 is represented by two-dimensional lines to establish the boundaries within a map created by the control system 20. The generation of the boundary 46 utilizing the raw data sensor points is performed using known algorithms and data manipulation processes. In one example, a Hough transform is applied to the raw data points 42 that define the straight line boundaries indicated at 46 in FIG. 3. It should be appreciated that other transform and algorithms that are capable of taking sensor data 42 and defining two-dimensional boundaries may also be utilized within the scope and contemplation of this disclosure.

Once the boundaries 46 are defined by the control system 20, a desired reference path 44 is defined. The reference path 44 is defined to move the vehicle 22 to a desired location. In this example embodiment, the vehicle 22 is being moved along a driveway to a target destination 45 that is a parking spot. The boundary 46 may be predefined or saved in the memory device 28 if the vehicle 22 has previously operated in an area. The boundary 46 may also be defined by the control system 20 as a map of an area new to the vehicle 22.

The reference path is defined to prevent the vehicle 22 from intersecting with any of the boundaries 46. In order to prevent the vehicle 22 from intersecting with any of the boundaries 46, the example control system 20 defines a clearance around the reference path 44. The clearance 48 is defined at spaced apart intervals along the reference path 44 from the location of the vehicle to the target final destination. The clearance 48 in one disclosed example embodiment is defined as a circle with a radius equal to at least one half the vehicle width 38. A series of these clearance circles 48 are centered on the reference path 44. Should any of the clearance circles 48 intersect with any of the boundaries 46 then the control system 20 would determine that the desired reference path would result in contact with one of the boundaries 46.

The reference path illustrated in FIG. 3 shows that most of the clearance circles 48 are well clear of the boundary 46. However, a contact point 47 between a few of the clearance circles 48 and the boundary 46 indicated a possible collision. Accordingly, the reference path 44 is modified based on the detected contact points 47 to provide a collision free path from the current location of the vehicle 22 to the target destination 45.

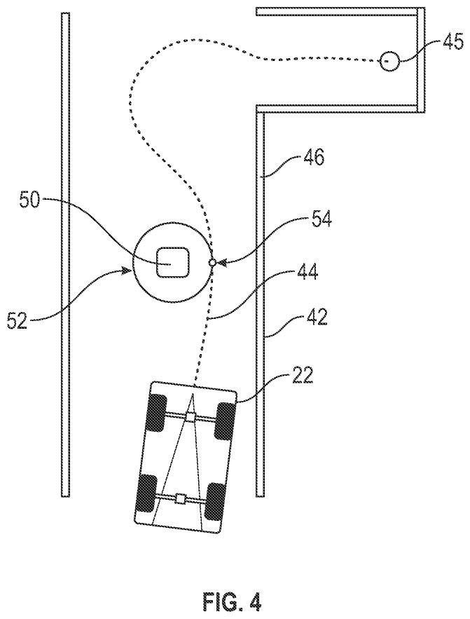

Referring to FIG. 4 with continued reference to FIG. 3, the example vehicle control system 20 is further operable to detect objects 50 that are disposed within the boundaries 42. Upon detection of an object 50, the control system 20 utilizes information from the sensors to determine if a possibility of a collision is present. In this disclosed embodiment, the vehicle control system 20 determines that a potential collision exists in response to the reference path 44 crossing over or through a clearance diameter 52 centered on the object 50.

In the example shown in FIG. 4, the vehicle 22 is set to proceed along the reference path 44. The reference path 44 intersects the clearance 52 of the object 50 at point 54. The intersection point 54 is indicative that some portion of the vehicle 22 would come into contact with the object 50. The vehicle control system 20 can utilize the information of the potential collision between the object 50 and the vehicle 22 to recalculate the desired path 44.

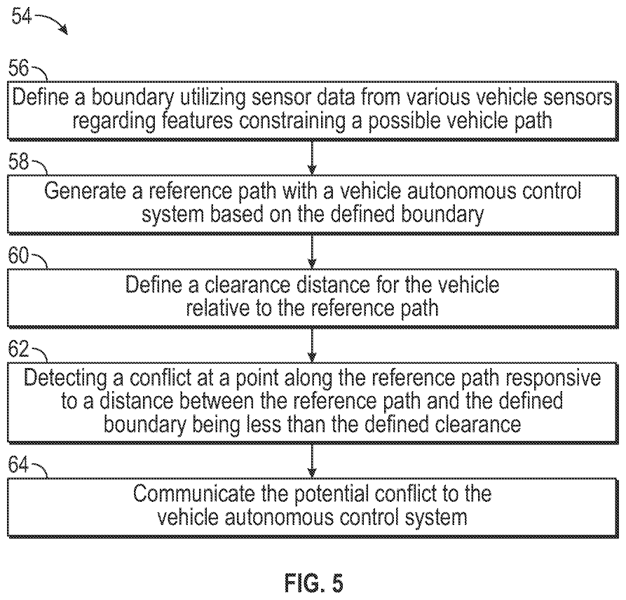

Referring to FIG. 5 with continues reference to FIGS. 3 and 4, a flow diagram is schematically indicated at 54 that illustrates steps taken by the vehicle control system 20 to detect a possible collision along a defined reference path 44. The disclosed system 20 initially defines the boundary 46 utilizing sensor data to obtain from various vehicle sensors 32,34,36 regarding features that may constrain operation of the vehicle 22 as is indicated at 56. The boundary 46 may be recalled from the memory device 28 and/or be generated during vehicle operation.

Definition of the boundary, according to one disclosed embodiment, may include use of raw data points to generate two-dimensional representations of objects surrounding the vehicle 22. In one disclosed embodiment, the boundary 46 represents surface the edge of a drivable surface, for example, a driveway. The vehicle control system 20 defines the boundaries 46 and then generates a reference path 44 in view of the boundaries 46 as is indicated at 58.

Definition of the reference path 44 is followed by a determination of a clearance distance 48 for the vehicle relative to the reference path 44 as is indicated at 60. The determination is made to assure that no part of the vehicle 22 will intersect with the boundary 46. In one disclosed embodiment, the clearance distance is uniform about a point centered on a point along the path 44. The clearance distance 48 is therefore defined as a circle and/or a plurality of circles that are centered along the reference path 44 and spaced apart at intervals. Each of the clearance circles is defined with the diameter that its at least as wide as a width of the vehicle 38. It should be appreciated that other geometric shapes could be utilized along with other widths to provide a desired clearance to assure that no portion of the vehicle 22 comes in contact with other objects.

The vehicle control system 20 uses the determined clearance to determine if a conflict is present between a detected object or the boundary as is indicated at 62. Once such a conflict is detected, that conflict will be communicated to the vehicle control system 20 as indicated at 64. The conflict is used by the control system 20 to modify vehicle operation as necessary to prevent undesired contact. The control system 20 may simply stop the vehicle 22 or generate a modification to the path 44 that routes the vehicle around the object 50 within the boundary 46.

The disclosed vehicle control system 20 embodiments provides for the detection of potential conflicts with objects and features surrounding a vehicle 22 so that corrective action and potential vehicle course corrections can be performed during autonomous operation.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A method of defining an autonomous vehicle path comprising:
defining a boundary utilizing sensor data indicative of features constraining a possible vehicle path;
generating a reference path with a vehicle autonomous control system based on the defined boundary;
defining a clearance distance for the vehicle relative to the reference path;
detecting a conflict at a point along the reference path responsive to a distance between the reference path and the defined boundary being less than the defined clearance; and
communicating the potential conflict to the vehicle autonomous control system.

2. The method as recited in claim 1, wherein the reference path comprises a plurality of points and the defined clearance comprises a circle centered on at least some of the plurality of points.

3. The method as recited in claim 2, wherein the circle comprises a diameter equal to or greater than a greatest width of the vehicle.

4. The method as recited in claim 1, wherein the sensor data comprises a plurality of points indicative of a boundary object and defining the boundary comprises defining a line based on the plurality of points.

5. The method as recited in claim 4, wherein the boundary object comprises a boundary separating different driving surfaces.

6. The method as recited in claim 4, wherein the boundary object comprises an object extending upwardly from a driving surface.

7. The method as recited in claim 1, further comprising detecting an object with the defined boundary based on sensor data and defining an object clearance around the detected object.

8. The method as recited in claim 7, wherein the object clearance is defined about the object and includes a spacing that provides a clearance between a vehicle moving along the reference path.

9. The method as recited in claim 7, wherein the object clearance comprises a collision radius that is at least half as wide as the vehicle.

10. An autonomous vehicle control system comprising:
a controller mountable within a vehicle that is configured to:
define a boundary utilizing sensor data indicative of features constraining a possible vehicle path;
generate a reference path with a vehicle autonomous control system based on the defined boundary;
define a clearance distance for the vehicle relative to the reference path;
detect a conflict at a point along the reference path responsive to a distance between the reference path and the defined boundary being less than the defined clearance; and
communicate the potential conflict to the vehicle autonomous control system.

11. The autonomous vehicle control system as recited in claim 10, wherein the reference path comprises a plurality of points and the defined clearance comprises a circle centered on at least some of the plurality of points.

12. The autonomous vehicle control system as recited in claim 11, wherein the circle comprises a diameter equal to or greater than a greatest width of the vehicle.

13. The autonomous vehicle control system as recited in claim 10, including at least one sensor configured to generate data comprising a plurality of points indicative of a boundary object proximate the vehicle and the controller is further configured define the boundary based on the plurality of points.

14. The autonomous vehicle control system as recited in claim 13, wherein the controller is further configured to detect an object within the boundary based on data from the sensor and to generate an object clearance around the detected object.

15. The autonomous vehicle control system as recited in claim 14, wherein the object clearance comprises a circle centered on the detected object, wherein the circle includes a radius at least as wide as half a greatest width of the vehicle.

16. The autonomous vehicle control system as recited in claim 14, wherein the controller is configured to define the object clearance as a spacing that provides a clearance between a vehicle moving along the reference path.

17. The autonomous vehicle control system as recited in claim 10, including at least one sensor generating information indicative of vehicle motion, position and direction and the controller is further configured to utilize information indictive of vehicle motion, position and direction to determine the reference path.

18. The autonomous vehicle control system as recited in claim 17, wherein the at least one sensor comprises at least one of a radar system, camera system or a lidar.

19. A non-transitory computer readable storage medium including instructions for operating an autonomous vehicle control system, the computer readable storage medium including:
instructions prompting a controller located within the autonomous vehicle to define a boundary utilizing sensor data indicative of features constraining a possible vehicle path;
instructions prompting the controller to generate a reference path with a vehicle autonomous control system based on the defined boundary;
instructions prompting the controller to define a clearance distance for the vehicle relative to the reference path;
instructions prompting the controller to detect a conflict at a point along the reference path responsive to a distance between the reference path and the defined boundary being less than the defined clearance; and
instructions prompting the controller to communicate the potential conflict to the vehicle autonomous control system.

20. The non-transitory computer readable storage medium as recited in claim 19, further comprising instructions for prompting the controller to detect an object with the defined boundary based on sensor data and define an object clearance around the detected object.
